(19) United States
(12) Patent Application Publication
(10) Pub. No.: US 2007/0298760 A1
(43) Pub. Date: Dec. 27, 2007

(54) Transmission of Service Relative Access Information When Identifying an Access Device Terminal of a Telecommunications Network

(76) Inventors: Peter Leis, Penzberg (DE); Rainer Liebhart, Munchen (DE)

Correspondence Address: STAAS & HALSEY LLP, SUITE 700, 1201 NEW YORK AVENUE, N.W., WASHINGTON, DC, 20005, US

(21) Appl. No.: 11/791,468

(22) PCT Filed: Nov. 11, 2005
(86) PCT No.: PCT/EP05/55924

§ 371 Date: May 24, 2007

(30) Foreign Application Priority Data
Nov. 25, 2004 (EP) 04028031.5

(51) Int. Cl. H04M 11/04

(52) U.S. Cl. 455/404.1

(57) ABSTRACT

An access data transmission independent of access data to a terminal and a terminal access data transmission to a service device are carried out by means of a transmission method (BRAS-ID/DSLAM-ID/ATM-VC-ID, Network-ID, Country Code-ID etc.). Said invention is characterised in that when identifying (1a, 1b) a terminal (terminal/DSL-modem/client) with respect to an access device (BRAS“/,,AAA”) of a telecommunications network (NGN-core-net), the terminal (terminal“/client”) receives and records a message (2) comprising access information and the (terminal“/client”) terminal, during a further contacting (,,SIP-emergency call-invite”/3.), transmits at least one part of said access information (3) to a service device (CSCF “and/or central emergency call 2”).

Cellular mobile networks such as 2G and 3G mobile networks are known to the person skilled in the art from the standards available, for example, under www.etsi.org and www.3GPP.com.

The organization ETSI TISPAN is currently working on the definition of the Next Generation Network NGN. The NGN is an IP based network that provides the subscribers with multimedia services (Voice, Video, Chat, Messaging, Gaming) and in the long term is aimed at replacing the existing TDM networks of the landline telephone operators. Hereby the Internet Protocol Multimedia Subsystem IMS (based on SIP) defined by 3GPP is to be adopted as the basis for the Session and Call Control Layer. Certain services must have access to a certain degree to location Information (information representing a location) or to origin information of the A-side (terminal side), so as to be able to offer their services in the optimum way (location related announcements, games, newsrooms, etc.). In addition, in the event of an emergency call, the network must, for example, take into account the origin of the subscriber in order to be able to route the call to the relevant emergency call centre.

In the cellular radio system (GSM, GPRS, UMTS) information such as the Mobile Country Code, Mobile Network Code and Cell ID can already be transmitted to the terminal via the radio interface. The terminal can then make this data available, for example in the SIP signaling (or in another signaling on the application layer), to the corresponding network nodes (IMS CSCF, Application Server, etc.). In an NGN with very heterogeneous access networks such as, for example, XDSL, WLAN or WiMax, there is as yet no uniform procedure for allowing access specific information to be sent to the terminal, which information the terminal can then use as required in the context of different applications.

One aim is to define a uniform and access independent mechanism with which the access network can transmit access specific information to the terminal. Thus the terminal is able to insert this information on the application layer into corresponding signaling messages (e.g. SIP messages). This means that the terminal receives the access-specific information using signaling of the “lower layers” (i.e. below the IP layer) and then inserts said information into the application protocol.

One solution discussed at ETSI TISPAN is based on the assumption that the terminal in general does not receive any origin-specific information from the access network, but this information is inserted by the first SIP proxy (the so-called outbound proxy, in the IMS this is the P-CSCF) into the SIP signaling (e.g. into an own SIP header).

This proposal has several disadvantages:
this goes against the SIP rule that a proxy is not allowed to modify or insert an end-to-end SIP header;
the SIP proxy has only very limited origin information available (e.g. network ID and country code), it does not recognize access specific data such as an ATM virtual channel ID or UMTS cell ID;
the network operator in which the SIP proxy is located, is not necessarily identical to the access network operator;
this information is only available for IMS applications using SIP as transport protocol, a priori other applications cannot access this data; thus it would be necessary either to define different mechanisms for different applications or the outbound proxy has to transmit its information via a new interface of a central function, which can then pass the information onto other applications.

One object of the present invention is to make it possible for access information to be made available to the mobile terminal regardless of the type of access network (cellular radio system of different standards, WLAN, DSL, WIMAX, ATM etc.) used by the mobile terminal or of the transmission technology used, which information said mobile terminal can then later transmit to the service device when registering and/or identifying with respect to a service device of a telecommunication network offering a service. The object is achieved in each instance by the subject matters of the independent claims.

Even when a mobile terminal has access to different telecommunication networks (such as, for example, landline/2G mobile terminal or 3G mobile network of different standards, DSL, WIMAX etc.) and/or different telecommunication network transmission methods (ATM etc.), the invention allows the mobile terminal to transmit relevant access information (such as, for example, country code, network ID, DSLAM location in particular for DSL/WIMAS, ATM channel ID information ATM VC ID, BRAS ID, WLAN access point ) etc. in the course of access authentication for different telecommunication network accesses (2G/3G/WLAN etc.) and/or transmission methods (ATM etc.), which information, can be recorded at the mobile terminal side (e.g. in the terminal or in a card at the mobile terminal side) and later, e.g. when contacting/identifying/ establishing a call to a service device offering a service (CSCF/emergency call centre etc.) can be transmitted to said service device (CSCF/emergency call centre). In particular, also during an access authentication (with respect to an AAA Server=Authentication, Authorization, Accounting Server) mobile terminals can receive data (which can be stored, for example mobile terminal/ identification card specific for one or several networks and/or one or several information transmission methods) and if the occasion arises when contacting a service via a telecommunication network (2G/3G/WLAN/WIMAX) and/or a transmission technology (ATM etc.) can transmit the stored data relevant for this network and/or transmission method to the service device (CSCF etc.) offering the service (for example, in a link establishing message such as a SIP message—in particular in a SIP message header).

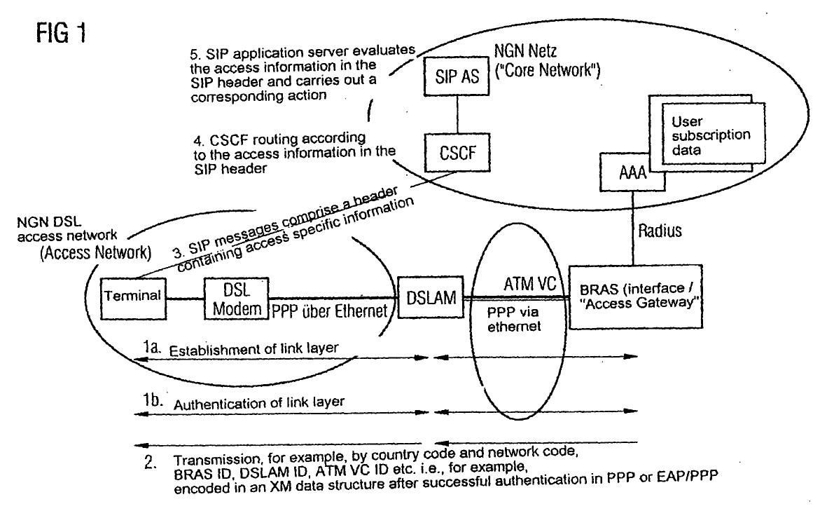

Preferably the mobile terminal receives access information (BRAS ID, DSLAM ID, ATMVC ID, country code, Network ID, DSLAM location etc.) during authentication of the terminal (for example, via a mobile network or WLAN or a different network) from an authentication server of a network, which information, at a later occasion, said mobile terminal, independently of said server, in order to make use of a service, transmits to a service device of the same or of a different network during the setup signaling (FIG. 1/3./SIP etc.).

Further features and advantages of the invention emerge from the following description of an exemplary embodiment with reference to the drawing, in which:

FIG. 1 shows a schematic representation of the transmission of access information to a terminal during an authentication and of the transmission of some of the access information received in this way from the terminal to a service device said terminal subsequently contacted,

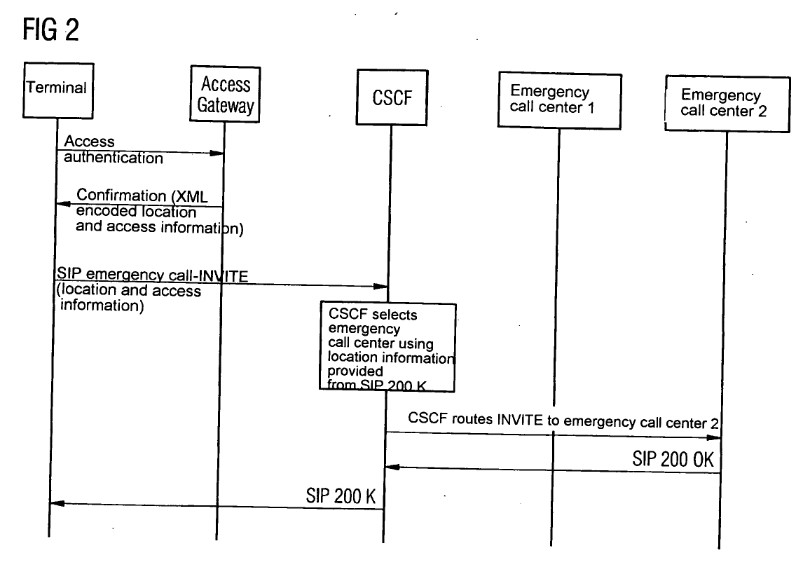

FIG. 2 shows a schematic representation, in the form of a flow diagram for an exemplary embodiment, of the steps during the transmission of access information during authentication and during a subsequent contacting of a emergency call service device.

FIG. 1 shows, by way of example, an AAA Server (Authentication/Authorization/Accounting—Server) with access to a memory for subscriber specific (terminal specific or subscriber identification card specific) data of a mobile network, which AAA Server, via a network access server (BRAS=broadband remote access server) and a DSLAM device and a DSL modem for the authentication, is connected to a terminal (client) and transmits to said terminal access information relating to the access via one or several access paths (2G/3G/WLAN etc.) and/or transmission technologies (ATM etc.). In the example in FIG. 1, after the establishment of a link-layer in Step la between the terminal (client/DSL modem) and the AAA Server (via DSLAM and BRAS) and an authentication of the terminal (client) with respect to the AAA Server in Step lb of an access device (here BRAS and/or AAA Server) of a telecommunication network, access information (country code/network code, BRASID, DSLAMID, ATMVCID etc.) for the same and/or a different telecommunication network (for example cellular mobile network/WLAN etc.) is sent by a network access device (here the AAA Server) in Step 2. The XML data format is used here for the transmission of the radio access data in Step 2.

A further proposal is, during the access authentication, to send access specific data such as Country Code, Network ID, DSLAM Location (in the case of DSL or WiMax), ATM VC ID, BRAS ID or WLAN Access Point Name (in the case of WLAN) to the client in a simple text string in an XML structure to be defined flexibly. This XML encoded structure can be extended as desired and contains parameters in order to transport information specific to all conceivable access networks and their architecture.

Parameters that are not relevant for an access network, are not engaged. Depending on the method of authentication, the text encoded in XML is transmitted to the terminal. In the DSL environment, for example PPP/PPPoE is normally used to establish an L2 link and to authenticate the subscriber. Within the PPP/PPPoE, the subscriber is prompted by the Access Server to identify himself and sends his username and password to the BRAS via the DSLAM. The BRAS then contacts a radius server, which carries out the actual authentication. If this is successful, the terminal is notified of the result in a PPP Frame. Optionally this PPP Frame can transmit additional data in existing data fields, such as, for example, the string text mentioned.

Even more flexible, and generally more practicable, is the Extensible Authentication Protocol (EAP), which can be transported e.g. via PPP/PPPoE, but also direct via IEEE 802.2 (EAPOL=EAP over LAN), so that, for example, EAP authentication for the access via WLAN and WiMax can be used. Within 3GPP, EAP-SIM and EAP-AKA were specified as authentication mechanisms for the access into the mobile core network via WLAN. EAP offers the possibility of sending additional information to the client within the response message to a successful EAP authentication.

If the client has received the access specific information during the authentication phase, it interprets the bytes received as an XML structure (string) and then analyses these to determine the data that is relevant to it. This data is eventually available to the applications, e.g. a SIP based IMS Client, so that it can be inserted into signaling messages on the application level. During the SIP registration or when setting up a SIP session, the access information is inserted into the corresponding SIP signaling messages (e.g. SIP REGISTER, SIP INVITE) by the terminal. In order to transport the access information, in the IMS the so-called P-Access-Network-Info header as defined in RFC 3455 is used. The definition of the P-Access-Network-Info header is access-specific and allows updates with respect of the connection type and the associated attributes (parameters were already specified for GERAN, UTRAN, and WLAN in accordance with 802.11a/b Standard). New access types and their associated attributes can now be defined within the P-Access-Network-Info header just as well in the NGN environment, too.

Examples might be: Access Type “NGN-DSL” with attributes “Country Code”, “Network Code”, “BRAS ID”, “DSLAM ID” and “ATM VC-ID”; Access Type “NGN-WLAN” with attributes “Country Code”, “Network Code”, “EBRAS ID”, “WLAN Access Point Name (SSID)”; Access Type “NGN-WIMAX” with attributes “Country Code”, “Network Code”, “BRAS ID”, “WiMax Base Station ID”.

Advantages of the method:
existing SIP rules are complied with, i.e. off-the-shelf SIP clients and stacks can be used;
the method is transparent for a P-CSCF in the IMS, which was implemented in accordance with 3GPP Standards 23.228 and 24.229;
access specific data is available to all applications that run on the terminal;
the encoding of the data is flexible as an XML structure and in principle can be extended as desired;
conventional protocols such as PPP/PPPoE or EAP/PPP are easily able to transfer additional data to the terminal during the access authentication.

Through the invention, a method is described with regards to how access-specific information can be transported in a flexible manner to a terminal during the access authentication, so that it is available later to different applications. As an example for such an application, the IMS was chosen that is already now capable in the P-Access-Network-Info header of sending the GERAN or UTRAN global Cell ID from the terminal to the CSCF. The aim of the invention is to make it possible also to use this mechanism in the NGN environment for the access network which mainly comes into consideration there such as DSL, WLAN or WiMax, so that the NGN-IMS and NGN services, if necessary, can receive this information from the terminal and, in the appropriate circumstances, evaluate.

In the following exemplary embodiment it is shown how a DSL-Client is authenticated using PPP with a BRAS in the NGN and when the authentication is successful receives access specific data from the BRAS or DSLAM. After this data has been evaluated, the SIP application on the terminal is able to place the P-Access-Network-Info header into SIP messages. S-CSCF and SIP application servers can then evaluate this data in order to offer, for example, location dependent services or in the case of emergency call to route to the correct emergency call centre.

FIG. 2 shows by way of example the transmission of access information to a terminal at its authorization with respect to an access device (access gateway) and the sending of access information, transmitted in this way, to a service device during the establishment of a link for an emergency call: In the first Step (corresponding to 1a/1b in FIG. 1) the terminal requests an access authentication from an access device (access gateway). The access device (access gateway) confirms the authentication of the terminal in a further Step (corresponding to 2, in FIG. 1) with a confirmation, which, in addition, for example, can contain access information encoded in XML (such as location and access information etc.). If, at a later point in time, the terminal wants to establish an emergency call to an emergency call centre, (in Step 3.) an emergency call announcement (here SIP emergency call invite message requesting the establishment of a link) with access information (which the terminal received beforehand from the access device access gateway in the confirmation 2) is transmitted to a service providing or service supporting service device (here CSCF). Based on the access information transmitted to it in the SIP emergency call invite message, the service device CSCF selects the service device (for example, the emergency call centre 2 in FIG. 2) that is appropriate for the terminal (in particular appropriate for its current location and/or appropriate for the transmission methods supported by it). Here the service device CSCF sends in response to a request (Invite) to establish a link and/or a service, a request to the emergency call centre 2, which here confirms said request in the SIP 200 OK message to the CSCF (Step 5), which confirms the establishment of the emergency call link in a (Step 6) SIP 200 OK confirmation message to the terminal. The emergency call service can, for example, consist only in this transmission of data from the terminal to the emergency call centre 2 or comprise in addition, for example, an establishment of a voice link etc.

In addition to the service described, a large number of other services are possible using the inventive method and devices.

1. A method for transmitting (2./3.) access information (BRAS-ID/DSLAM-ID/ATM-VC-ID, Network ID, Country Code ID etc.), characterized in that when identifying (1a, 1b) a terminal (“terminal”/DSL-Modem/Client) with respect to an access device (“BRAS”/“AAA”) of a telecommunication network (NGN Core-network), the terminal (“terminal”/“Client”) receives and records a message (2) comprising access information, and in that the terminal (“terminal”/“Client”) during a further contacting (“SIP emergency call invite”/3.) transmits at least one part of said access information (3) to a service device (“CSCF” and/or “emergency call centre 2”).

2-20. (canceled)
